(19) United States
(12) Patent Application Publication
(10) Pub. No.: US 2007/0265761 A1
(43) Pub. Date: Nov. 15, 2007

(54) ELECTRIC POWER GENERATION SYSTEM AND METHOD

(76) Inventors: Kevin Allan Dooley, Mississauga (CA); Jeseph Horace Brand, Mississauga (CA)

Correspondence Address: OGILVY RENAULT LLP (PWC), 1981 MCGILL COLLEGE AVENUE, SUITE 1600, MONTREAL, QC, H3A 2Y3, CA

(21) Appl. No.: 11/382,780

(22) Filed: May 11, 2006

(51) Int. Cl. G06F 19/00

(52) U.S. Cl. 701/100

(57) ABSTRACT

The electric power generation system is to be used with a gas turbine engine. It preferably includes a continuously variable transmission connected between the low-pressure spool of the engine and an electric generator, preferably to step-up the speed therebetween and drive the generator at a substantially constant speed.

### TECHNICAL FIELD

The invention relates to gas turbine engines, and in particular to a system and a method for generating electric power.

### BACKGROUND

In recent years, there has been an increasing demand in electric power generated by gas turbine engines mounted on aircrafts. However, the amount of power that can be taken from the high pressure or HP turbine shaft affects the operability of the engine and also increases fuel consumption, and so generators may also or alternately be driven by with the low pressure or LP turbine shaft. However, this results in design trade-offs, and therefore there is room for improvement in design.

### SUMMARY

In one aspect, the present invention provides a gas turbine engine system comprising at least a low-pressure (LP) shaft and a high-pressure (HP) shaft of the gas turbine engine, a step-up continuously variable transmission (CVT) assembly having an input and an output, the output adapted to rotate at a selected substantially constant speed higher than a speed on the input, the input of the CVT assembly drivingly connected to the LP spool, and an electric generator drivingly connected to the output of the CVT assembly.

In another aspect, the invention provides a method of generating power from a gas turbine engine, the method comprising: rotating a low-pressure (LP) shaft in the engine; using a device to controllably stepping-up rotation speed between an input driven by the LP shaft and an output shaft of the device; and using the output shaft of the device to drive a generator.

In another aspect, the invention provides a method of providing a gas turbine engine power generation system, the method comprising the steps of: providing a gas turbine engine, the engine having a pre-specified power requirement and a pre-determined space envelope adjacent a main shaft of the engine; providing an electric generator having a design and a size satisfying said pre-specified power requirement and pre-determined space envelope; determining a generator speed required to meet said pre-specified power requirement given said generator size; providing a speed step-up device adapted to be driven by the main shaft of the engine and drive the generator at said speed, wherein said speed is higher then a speed of the main shaft.

### BRIEF DESCRIPTION OF THE FIGURES

Reference will now be made to the accompanying figures, in which:

FIG. 1 is a schematic cross-sectional view of an example of a gas turbine engine as improved herein; and

FIG. 2 is a block diagram of a control arrangement for the engine of FIG. 1.

### DETAILED DESCRIPTION

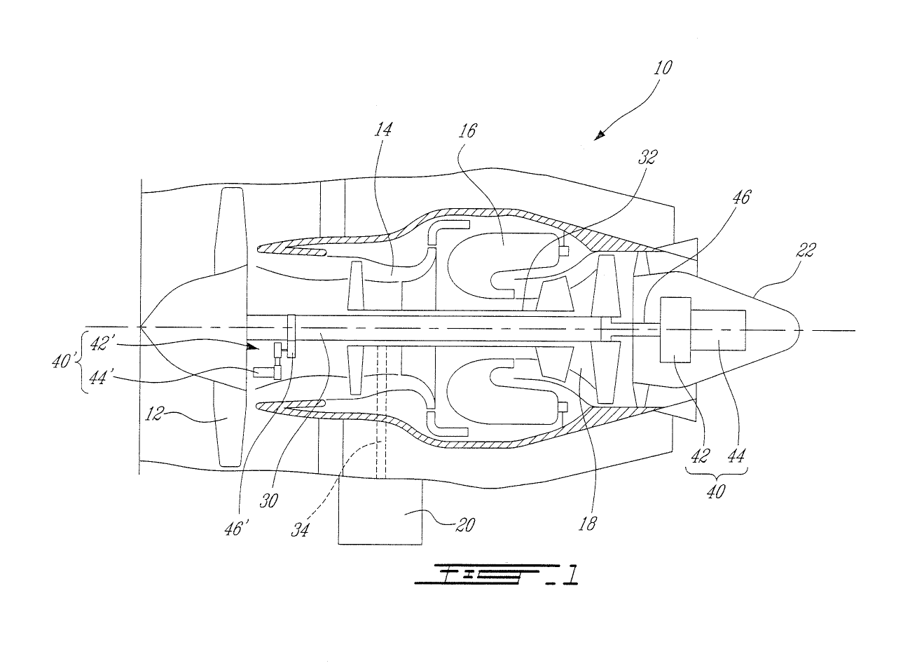

FIG. 1 schematically illustrates an example of a gas turbine engine 10 which generally comprises in serial flow communication a fan 12 through which ambient air is propelled, a multi-stage compressor 14 for pressurising the air, a combustor 16 in which the compressed air is mixed with fuel and ignited for generating a stream of hot combustion gases, and a turbine section 18 for extracting energy from the combustion gases. The engine 10, in this embodiment, also has an auxiliary or accessory gearbox (AGB) 20 on which are located mechanical and electrical systems, such as fuel pumps, oil pumps, a starter and a generator, or an integrated starter/generator, etc.

The main rotating parts of the engine 10 are connected in two subgroups, one being referred to as the low pressure (LP) spool and the other being the high pressure (HP) spool. The LP spool usually comprises the fan 12, the portion of the turbine section 18 that is located at the rear of the engine 10 and an LP shaft 30 connecting them together. The HP spool comprises the multi-stage compressor 14, or at least the portion thereof that is closer to the combustor 16, the portion of the turbine section 18 that is closer to the combustor 16 and an HP shaft 32 connecting them together. The LP shaft 30 and the HP shaft 32 are coaxially disposed. The AGB 20 is connected to the HP shaft 32 through a tower shaft 34 and corresponding gears (not shown).

An engine power generation system 40 is preferably concentrically driven by the LP shaft 30 (As mentioned, FIG. 1 is somewhat schematic, and also shows an alternate system 40′, which is discussed further below). The LP spool has the capability to deliver the required high power without engine operability issues and with less increase in fuel consumption than the HP spool. This power generation system 40 can be complementary or can even replace the one used in the AGB 20. It can also be used in engines without an AGB (i.e. with a so-called integral starter-generator, concentrically mounted on the HP shaft, replacing the AGB). FIG. 1 shows that the system 40 is located at the rear end the LP shaft 30, aft of the LP turbine portion of turbine section 18, and fits within the dimensional limits of the tail cone 22 of engine 10. The tail cone 22 is preferably provided with heat insulation and ventilation to provide a sufficiently suitable environment for system 40.

The system 40 comprises a continuously variable transmission (CVT) 42 that is preferably concentrically mounted to a generator 44 and drivingly connected to the LP shaft via connection 46. The CVT 42 preferably has a step-up transmission ratio to increase the rotation speed of the generator 44, connected at the output thereof, relative to the input speed provided by the LP shaft. It may also provide a constant high speed for driving the generator 44. The generator 44 is preferably a permanent magnet generator, which provides good power density and reliability relative to other machine designs, although any suitable electric generator may be used. Preferably, also, the generator 44 has a multiple-redundant, preferably concentrically-mounted design for intrinsic back-up purposes. As mentioned, the input of the CVT 42 receives power from the LP shaft 30 via a connection 46. The provisions of the CVT 42 simplifies the power electronics (not shown) used to condition generator output power, since a constant speed generator, particularly of the permanent magnet type, tends to produce constant voltage/constant frequency output power, which thus requires less complex regulation. This, too, has beneficial weight and cost implications for the aircraft.

The CVT 42 may be any suitable type. In the preferred embodiment, a toric drive type CVT is provided which preferably produces a constant speed output when driven by a variable speed input. Other suitable types of CVT transmissions may be used, for example those using a drivebelt and pulleys or other CVT types may be suitable.

As mentioned, the CVT 42 preferably also provides a step-up speed ratio relative to the LP shaft speed. Since the size of an electrical generator is proportional to the power output, the faster the generator rotates, the smaller it can be for a given power output. The CVT 42 can thus be used to maintain the rotation speed of the generator 44 at its maximum or its optimum speed, regardless of the rotation speed of the LP shaft 30. The LP shaft 30 typically rotates slower that the HP shaft 32 which, until now, as had negative implications for power density available from LP shaft power generation, but the CVT 42 of the present arrangement alleviates this drawback, and allows the designer the flexibility to select optimum conditions for generator speed, size, weight, etc. and yet still meet power demands. As a result, the generator 44 can be relatively small because of the high power density associated with high speed generator operation. This also helps the designer to fit the parts in the dimensional limits of the engine 10, and permits the possibility that the system 40 can be installed on existing engine designs which do not specifically provide an envelope for LP shaft-mounted power generation.

Optionally, CVT 42 may include a more conventional type step-up gearbox on the input side, between the connection 46. The optional gearbox can be used to further increase the rotation speed before the input of the CVT 42, if needed, which perhaps permits the design and/or operational requirements of CVT 42 to be simplified.

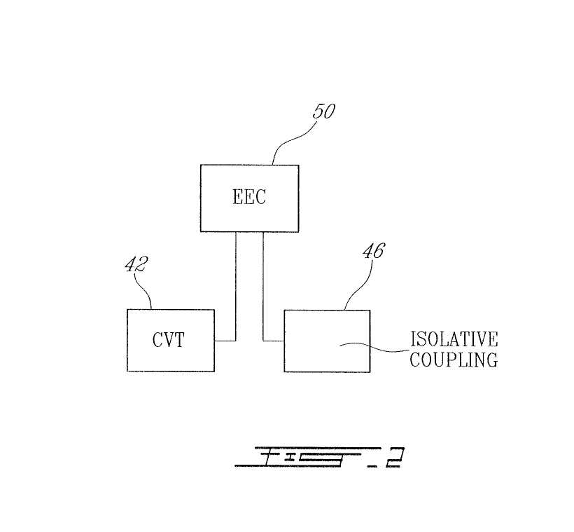

The connection between the LP shaft 30 and the input of the CVT 42 may have any suitable configuration, and preferably includes an isolative coupling with connection 46, to permit selective release of the mechanical connection between the LP shaft 30 and the CVT 42. FIG. 2 is a block diagram showing an example of an engine electronic control (EEC) 50 for engine 10 which is also connected to both the CVT 42 and the isolative coupling provided in connection 46. The EEC 50 can thus command the disconnection of the system, for example, in the case of a failure of system 40, or other suitable situations.

In use, the CVT 42 can also be controlled by the EEC 50. The EEC 50 can be programmed to take into consideration various factors, such as the rotation speed of the LP shaft 30, the power requirements at that moment, etc. The CVT 42 can be used to change the generator input speed continuously and allow the generator 44 to be always driven at the highest possible speed and/or at its optimum speed, as desired. The present system thus improves aircraft power generation to provide a lighter weight, higher power system for a given engine design.

Referring again to FIG. 1, a power generation system 40′ may be provided at a forward end of LP shaft 30, behind fan 12, preferably alternately to system 40, or in addition to system 40 as depicted in FIG. 1, as desired. In this arrangement generator 44′ is off-settedly mounted relative to shaft 30, rather than concentrically, although the skilled reader will appreciate that other suitable mounting arrangements may be used. A CVT 42′ is interposed between shaft 30 and generator 44′. The design and arrangement is otherwise according to the above teachings.

The above description is meant to be exemplary only, and one skilled in the art will recognize that other changes may also be made to the embodiments described without departing from the scope of the invention disclosed as defined by the appended claims. For instance, the step-up gearbox can be used without an isolation coupling and be provided adjacent to either the input or the output of the CVT. The engine power generation system can be controlled by another device than the EEC. The generator may be any suitable type, as may the CVT be any suitable type.

What is claimed is:

1. A gas turbine engine system comprising at least a low-pressure (LP) shaft and a high-pressure (HP) shaft of the gas turbine engine, a step-up continuously variable transmission (CVT) assembly having an input and an output, the output adapted to rotate at a selected substantially constant speed higher than a speed on the input, the input of the CVT assembly drivingly connected to the LP spool, and an electric generator drivingly connected to the output of the CVT assembly.

2. The system as defined in claim 1, wherein the input of the CVT assembly includes a step-up gear assembly on an input side of the CVT assembly.

3. The system as defined in claim 1, wherein the step-up gear assembly is a fixed ratio gear assembly.

4. The system as defined in claim 1, wherein the input of the CVT assembly is connected to the LP shaft through an isolative coupling.

5. The system as defined in claim 1, further comprising an electronic controller connected to the CVT assembly and adapted to select said selected substantially constant speed.

6. The system as defined in claim 5, wherein the controller selects said substantially constant speed based on at least one engine operating parameter.

7. The system as defined in claim 5, wherein the controller selects said substantially constant speed based on at least one power requirement of a load system connected to the generator.

8. The system as defined in claim 1, wherein the generator is a generator assembly comprising multiple redundant generators concentrically mounted with one another.

9. The system as defined in claim 1, wherein the CVT assembly includes a toric drive.

10. The system as defined in claim 1 wherein the generator is mounted substantially concentrically with the LP shaft.

11. The system as defined in claim 1 wherein the CVT assembly is mounted substantially concentrically with the LP shaft.

12. A method of generating power from a gas turbine engine, the method comprising:
rotating a low-pressure (LP) shaft in the engine;
using a device to controllably stepping-up rotation speed between an input driven by the LP shaft and an output shaft of the device; and
using the output shaft of the device to drive a generator.

13. The method as defined in claim 12, wherein the device includes a continuously variable transmission.

14. The method as defined in claim 12, wherein the device includes a fixed-ratio gear system.

15. The method as defined in claim 12, wherein the step of controllably stepping-up rotation speed includes providing a substantially constant output speed of said output shaft regardless of an input speed of the device.

16. A method of providing a gas turbine engine power generation system, the method comprising the steps of:
providing a gas turbine engine, the engine having a pre-specified power requirement and a pre-determined space envelope adjacent a main shaft of the engine;
providing an electric generator having a design and a size satisfying said pre-specified power requirement and pre-determined space envelope;
determining a generator speed required to meet said pre-specified power requirement given said generator size;
providing a speed step-up device adapted to be driven by the main shaft of the engine and drive the generator at said speed, wherein said speed is higher then a speed of the main shaft.

17. The method of claim 16 further comprising the step of driving the generator substantially constantly at said speed.

18. The method of claim 16 wherein both the speed step-up device and generator are sized to fit within said envelope.

19. The method as defined in claim 16, wherein the speed step-up device includes a continuously variable transmission.

20. The method as defined in claim 16, wherein the speed step-up device includes a fixed-ratio gear system.
